(19) United States
(12) Patent Application Publication
(10) Pub. No.: US 2025/0025800 A1
(43) Pub. Date: Jan. 23, 2025

(54) Enrichment System

(71) Applicant: Laura Marie Emory, Cocoa Beach, FL (US)

(72) Inventor: Laura Marie Emory, Cocoa Beach, FL (US)

(21) Appl. No.: 18/778,980

(22) Filed: Jul. 20, 2024

Related U.S. Application Data
(60) Provisional application No. 63/528,212, filed on Jul. 21, 2023.

(51) Int. Cl. A63H 5/00; A01K 15/02

(52) U.S. Cl. CPC A63H 5/00; A01K 15/026

(57) ABSTRACT

The present disclosure provides generally for enrichment systems. An enrichment system may facilitate entertainment and stimulation for a user, wherein the user may comprise an animal or a human. In some aspects, an enrichment system may comprise at least one housing that comprises at least one opening, wherein the opening may facilitate the removal of at least one portion of each of one or more removably insertable elements. In some embodiments, each removably insertable element may comprise at least one non-fraying and non-edible material in the form of one or more at least partially flexible elongated members, such as strips or straps. In some aspects, a user may pull at least one portion of each removably insertable element through the opening, which may facilitate entertainment or enrichment for the user, whereafter any portion of the removably insertable element removed from the housing may be reinserted for subsequent use.

### CROSS-REFERENCE TO RELATED APPLICATION

This application claims priority to and the full benefit of U.S. Provisional Patent Application Ser. No. 63/528,212 (filed Jul. 20, 2024, and titled “Enrichment System”), the entire contents of which are incorporated in this application by reference.

### BACKGROUND

Toys have existed since the beginning of human civilization. It was the onset of the industrial revolution that enabled toys to be mass produced, offering access to affordable options. As the market for toys expanded, the focus of toy design shifted to include more safety considerations. The hazards associated with toys were varied, including but not limited to, choking risks, sharp edges, loud noises, and toxic substances. Manufacturers benefitted from creating toys that avoided these safety concerns.

Toy manufacturers who did not elect to produce safe products were eventually forced to. In the U.S., for example, various laws set forth a mandatory set of safety rules under the Standard Consumer Safety Specification for Toy Safety. Nowadays, the vast majority of toys are very safe for use and contain a variety of safety warnings to place users on notice of any potential dangers. Unfortunately, this focus on safety has only been applied to the development of human toys. Animals and pet toys lag behind in terms of safety, as the hazards posed by animal use are not identical to humans and require different design considerations.

Part of the reason animal toy safety has not been addressed as thoroughly as human toy safety is that toys designed and manufactured for animals have not been in existence as long. In fact, it was not until the 1920s that department stores began to offer sections dedicated specifically to animal toys. Even still, options in these stores were limited to simple designs. In the 1950s, some stores began introducing artificial bones and hide, toy rope, and many of the other designs that are commonly seen today. While there has been a recent trend to diverge from some of these harmful designs, especially artificial bones and rawhide, there are still many risks associated with many modern animal toys.

Despite the existing risks, animal toys offer many potential benefits. Animals, especially domesticated animals, require exercise and intellectual stimulation to stay mentally and physically healthy. Playing with toys helps these animals stay active and moving while also keeping them mentally well. Without the enrichment received from toy use, animals are likely to develop more destructive and dangerous behavior. This may force animal caretakers to balance the training and raising of animals with their own safety, a tradeoff that could be avoided if the risks and flaws of current toy designs were properly addressed.

One common type of animal toy includes stuffed plush toys that comprise different shapes that often represent different animals or objects. These stuffed toys can easily be torn open by certain types of animals, such as dogs and cats, leading to both a large mess and a potential choking hazard for humans and the animals alike. Despite the pleasure many animals get from ripping these toys apart, the resulting mess and concern for an animal's well-being often deter many pet owners from purchasing these products.

### SUMMARY OF THE DISCLOSURE

What is needed are enrichment systems configured to stimulate, educate, or entertain users without exposing a user to potential ingestion of harmful material. Enrichment systems that are reusable and that do not leave a mess after use are also desired.

In some aspects, the present disclosure is directed to an enrichment system that comprises at least one housing, wherein the at least one housing comprises at least one internal cavity configured within an interior portion of the at least one housing; at least one opening; and one or more removably insertable elements, wherein the one or more removably insertable elements are configured to be at least temporarily stored within the at least one internal cavity, wherein the at least one opening may facilitate removal of at least one portion of each of the one or more removably insertable elements from the at least one internal cavity.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1A illustrates a top view of an exemplary enrichment system, according to some embodiments of the present disclosure.

FIG. 1B illustrates a bottom view of an exemplary enrichment system, according to some embodiments of the present disclosure.

FIG. 2 illustrates a perspective view of an exemplary enrichment system, according to some embodiments of the present disclosure.

FIG. 3A illustrates a top view of an exemplary enrichment system, according to some embodiments of the present disclosure.

FIG. 3B illustrates a perspective view of an exemplary enrichment system, according to some embodiments of the present disclosure.

FIG. 4 illustrates an exemplary enrichment system being used by an animal user, according to some embodiments of the present disclosure.

FIG. 5 illustrates an exemplary enrichment system being used by a human user, according to some embodiments of the present disclosure.

FIG. 6 illustrates a top view of an exemplary enrichment system, according to some embodiments of the present disclosure.

FIG. 7A illustrates a top view of an exemplary enrichment system, according to some embodiments of the present disclosure.

FIG. 7B illustrates a bottom view of an exemplary enrichment system, according to some embodiments of the present disclosure.

FIG. 7C illustrates a top view of an exemplary enrichment system, according to some embodiments of the present disclosure.

FIG. 7D illustrates a bottom view of an exemplary enrichment system, according to some embodiments of the present disclosure.

FIG. 7E illustrates a top view of an exemplary enrichment system, according to some embodiments of the present disclosure.

FIG. 8 illustrates an exemplary enrichment system, according to some embodiments of the present disclosure.

FIG. 9 illustrates an exemplary enrichment system, according to some embodiments of the present disclosure.

FIG. 10 illustrates an exemplary enrichment system, according to some embodiments of the present disclosure.

The Figures are not necessarily drawn to scale, as their dimensions can be varied considerably without departing from the scope of the present disclosure.

### DETAILED DESCRIPTION

The present disclosure provides generally for enrichment systems. According to the present disclosure, enrichment systems may facilitate entertainment and stimulation for a user. In some implementations, the user may comprise a pet, such as a dog, cat, or rabbit, as non-limiting examples. In some embodiments, the user may comprise at least one human, wherein the human user may benefit from use of the enrichment system by developing increased mobility or receiving stimulation or entertainment, as non-limiting examples. In some aspects, an enrichment system may comprise at least one opening, wherein the at least one opening may facilitate the removal of one or more of removably insertable elements. In some embodiments, a removably insertable element may comprise a non-fraying and non-edible material in the form of one or more at least partially flexible elongated members, such as strips or straps, as non-limiting examples.

In some aspects, the enrichment system may comprise at least one internal cavity, wherein the at least one internal cavity may be configured to receive and at least temporarily store at least a portion of the removably insertable elements. In some embodiments, the enrichment system may comprise at least one housing, wherein the at least one opening may be configured on an exterior surface of the housing to provide access to the internal cavity configured therein and facilitate removal of at least a portion of the removably insertable elements within the internal cavity by a user.

In some implementations, the enrichment system may comprise at least one closure mechanism, wherein the closure mechanism may be configured to be altered between an open state and a closed state, wherein a user may be able to insert or remove at least a portion of each removably insertable element into or from the cavity when the closure mechanism is in an at least partially open state.

In some aspects, a user may be able to pull one or more of the removably insertable elements from the enrichment system through the opening, which may facilitate entertainment for the user. In some non-limiting exemplary implementations wherein the user may comprise a dog, the dog may use one or more teeth to pull at least a portion of each removably insertable element through the opening, which may mimic pulling or tearing the stuffing from a stuffed animal. In some embodiments, the non-fraying and non-edible nature of the elongated members comprising the removably insertable elements may cause the removably insertable elements to be unlikely to be ingested by the dog, which may help reduce the possibility that the dog may ingest any potentially harmful materials.

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Removably insertable element: as used herein refers to any material or item that may be placed at least partially within at least one portion of an enrichment system. By way of example and not limitation, a removably insertable element may comprise at least one non-fraying, non-shedding, and non-edible material. In some aspects, a removably insertable element may comprise one or more at least partially flexible elongated members of non-fraying material, such as strips or straps, as non-limiting examples. In some non-limiting exemplary embodiments, a removably insertable element may at least partially comprise a squeaker, food item, edible element, or audio emitting device, as non-limiting examples. As a non-limiting illustrative example, a removably insertable element may be reused or replaced, wherein a removably insertable element may be reinserted into at least one cavity within a housing of an enrichment system after the removably insertable element has been removed therefrom at least once.

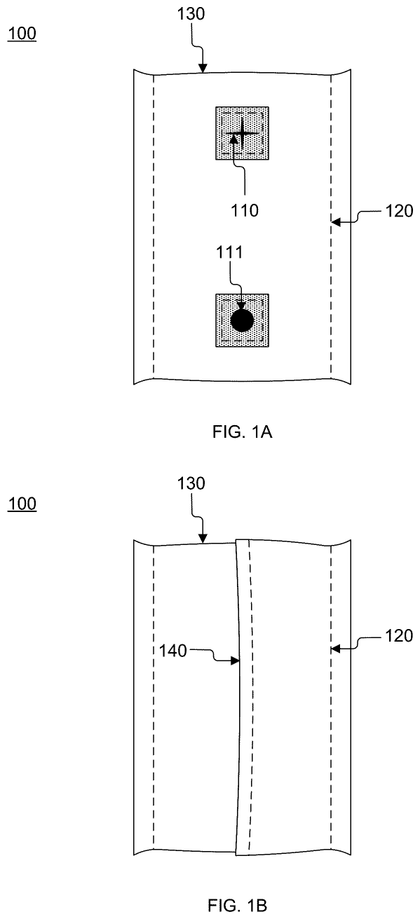

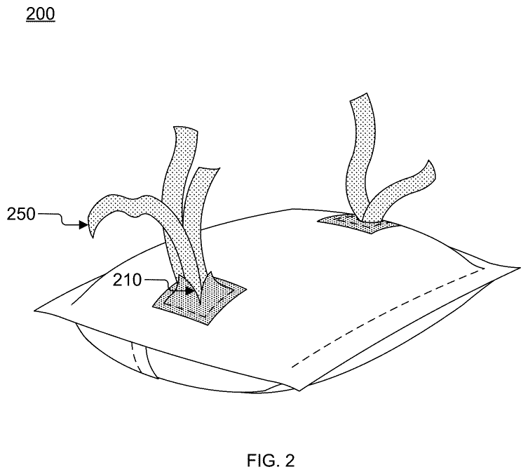

Referring now to FIGS. 1A and 1B, a top and bottom view of an exemplary enrichment system 100, according to some embodiments of the present disclosure, are illustrated. In some aspects, the enrichment system 100 may comprise at least one opening 110, 111, wherein each opening 110, 111 may facilitate the removal of at least one portion of each of one or more removably insertable elements. In some implementations, the enrichment system 100 may comprise a plurality of openings 110, 111. In some embodiments, a plurality of openings 110, 111 may enhance the enriching capabilities of the enrichment system 100 by providing a user with multiple openings 110, 111 through which to remove the removably insertable elements. In some aspects, each of the plurality of openings 110, 111 may comprise a unique shape or size that may be at least partially different from the shape or size of one or more other openings 110, 111.

In some aspects, by way of example and not limitation, at least one of the openings 110 may comprise at least one elongated slit. In some implementations, the elongated slit may comprise a length of approximately one inch. In some non-limiting exemplary embodiments, at least one of the openings 111 may comprise a buttonhole style slot that comprises a diameter of approximately one inch. In some implementations, by comprising a variety of sizes or shapes, the plurality of openings 110, 111 may facilitate different levels of enrichment for a user.

In some embodiments, an outer perimeter of one or more of the openings 110, 111 may comprise an edge portion that comprises one or more of a variety of materials which may add to the enrichment capabilities or enhance the stability of and structural integrity of the relevant opening 110, 111. By way of example and not limitation, an edge portion of one or more of the openings 110, 111 may at least partially comprise an amount of one or more of: plastic, silicone, metal, or fabric, as non-limiting examples.

In some aspects, the enrichment system 100 may comprise at least one internal cavity 120, wherein the internal cavity 120 may be configured to receive and at least temporarily store at least one portion of each removably insertable element. In some aspects, the enrichment system 100 may comprise a plurality of internal cavities 120. In some implementations, each of the plurality of cavities 120 may comprise a unique shape or size that at least partially differs from the shape or size of one or more other cavities 120.

As a non-limiting illustrative example, a cavity 120 may be configured to hold at least six removably insertable elements in the form of strips or straps. In some embodiments, the enrichment system 100 may comprise at least one housing 130, wherein one or more openings 110, 111 may be configured within an external surface of the housing 130, and wherein at least one internal cavity 120 may be configured within the housing 130 such that access to the cavity 120 and any removably insertable elements therein may be facilitated by the openings 110, 111. In some aspects, the housing 130 may comprise one or more of a variety of shapes, sizes, or textures, as non-limiting examples. As a non-limiting illustrative example, a housing 130 may comprise a rectangular shape that comprises the colors blue and yellow, which may be enriching colors for a user that comprises a dog.

In some implementations, the enrichment system 100 may comprise at least one closure mechanism 140, wherein the closure mechanism 140 may be configured to be altered between a closed state and an open state, wherein a user may be able to insert or remove at least a portion of each removably insertable element into or from the cavity 120 when the closure mechanism 140 is in an at least partially open state. In some embodiments, the closure mechanism 140 may comprise one or more flaps of material to form an overlapping pocket opening, which may provide a secondary opening for a user to remove or insert each removably insertable element.

In some implementations, the closure mechanism 140 may comprise one or more of: a button, zipper, or hook-and-loop fastener, as non-limiting examples. In some aspects, at least one portion of the enrichment system 100 may be configured to be machine washable, which may be convenient for a human user.

In some embodiments, the insertable element may include strips of fabric, as a non-limiting example. In some aspects, the insertable element may include different colors or different fabrics. In some implementations, the insertable element may include words written onto the insertable element, wherein the withdrawal of the insertable element may be used to educate a user. By way of example and not limitation, the words written onto the insertable element may be related to the design of the enrichment system.

In some aspects, the enrichment system 100 may be utilized by at least one user that comprises a human. By way of example and not limitation, a human user may benefit from using the enrichment system 100 to receive assistance with improving mobility or motor skills, receive mental stimulation, or engage in an entertaining experience. In some implementations, the enrichment system 100 may be used in educational or occupational therapy settings, as non-limiting examples. In some aspects, the enrichment system 100 may include pictures of animals, items, objects, or people, wherein the pictures of animals, items, objects, or people may be used as an educational tool. In some implementations, the at least one that comprises a human may include a child, wherein the pictures of animals, items, objects, or people may help to educate the child on the identity and qualities of the pictures. By way of example and not limitation, the pictures used for educational purposes may include colors, exercises, alphanumerical characters, animals, objects, or people, wherein the pictures may be used to educate a human.

Referring now to FIG. 2, an exemplary enrichment system 200, according to some embodiments of the present disclosure, is illustrated. In some aspects, the enrichment system 200 may comprise at least one opening 210, wherein the at least one opening 210 may facilitate the removal of at least one portion of each of one or more removably insertable elements 250. By way of example and not limitation, each removably insertable element 250 may comprise at least one non-fraying, non-shedding, and non-edible material. In some aspects, each removably insertable element 250 may comprise an at least partially flexible elongated member comprising at least one non-fraying material, such as a strip or strap, as non-limiting examples. In some embodiments, one or more removably insertable elements 250 may comprise one or more of: a squeaker, a food item, an edible element, or an audio emitting device, as non-limiting examples. In some aspects, each removably insertable element 250 may be configured to be replaced, reused, or reinserted a plurality of times, which may contribute to the longevity of the enrichment system 200. As a way of example and not limitation, the enrichment system 200 may be used as an object for fetching and playing tug, as non-limiting examples.

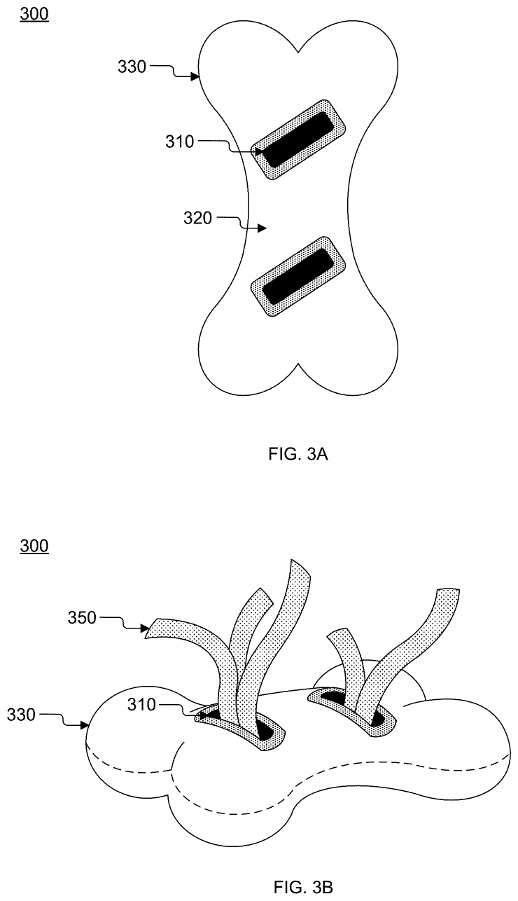

Referring now to FIGS. 3A and 3B, a top view and a perspective view of an exemplary enrichment system 300, according to some embodiments of the present disclosure, are illustrated. In some aspects, the enrichment system 300 may comprise at least one opening 310, wherein each opening 310 may facilitate the removal of at least one portion of each of one or more removably insertable elements 350. In some implementations, the enrichment system 300 may comprise a plurality of openings 310. In some embodiments, comprising a plurality of openings 310 may enhance the enrichment capabilities of the enrichment system 300 by giving a user multiple openings 310 from which to remove the removably insertable elements 350. In some aspects, each of the plurality of openings 310 may comprise a unique shape or size that at least partially differs from one or more other openings 310.

In some embodiments, by comprising a variety of sizes and shapes, the plurality of openings 310 may facilitate different levels of enrichment for a user. As a non-limiting illustrative example, removing a removably insertable element 350 through a first opening 310 that comprises a diameter of half an inch may be more difficult for a user than removing a removably insertable element 350 from a second, larger opening 310 that comprises a diameter of one inch. In some aspects, this varying difficulty may mentally stimulate the user and may require increased mobility by the user to successfully remove each removably insertable element 350 from the cavity 320 within a housing 330 of the enrichment system 300, which may increase the overall enjoyment and beneficial experience achieved from use of the enrichment system 300 by the user.

In some implementations, an outer perimeter of each opening 310 may comprise an edge portion that comprises one or more of a variety of materials which may add to the enrichment capabilities or enhance the stability or structural integrity of the opening 310. By way of example and not limitation, the edge portion of one or more of the openings 310 may at least partially comprise a material that comprises an amount of one or more of: plastic, silicone, metal, or fabric, as non-limiting examples. In some non-limiting exemplary embodiments, an outer perimeter of each opening 310 may comprise one or more of a variety of materials that may mentally stimulate a user by providing a variety of visual, tactile, or olfactory experiences to the user.

In some aspects, the enrichment system 300 may comprise at least one internal cavity 320, wherein each internal cavity 320 may be configured to receive and at least temporarily store at least one portion of each removably insertable element 350. In some aspects, the enrichment system 300 may comprise a plurality of cavities 320. In some implementations, each of the plurality of cavities 320 may comprise a unique shape or size that at least partially differs from one or more other cavities 320. As a non-limiting illustrative example, a cavity 320 may be configured to hold at least six removably insertable elements 350 comprising strips, straps, or similar structures.

In some embodiments, the enrichment system 300 may comprise at least one housing 330, wherein at least one opening 310 may be configured within an external surface of the housing 330 and wherein the internal cavity 320 may be configured within an interior portion of the housing 330 such that the openings 310 may facilitate access to the cavity 320 and any removably insertable elements 350 that may be therein. In some aspects, the housing 330 may comprise one or more of a variety of different shapes, sizes, or textures, as non-limiting examples. As a non-limiting illustrative example, a housing 330 may comprise a bone shape that comprises blue and yellow coloring, wherein such coloring and shape may be enriching to a user that comprises a dog.

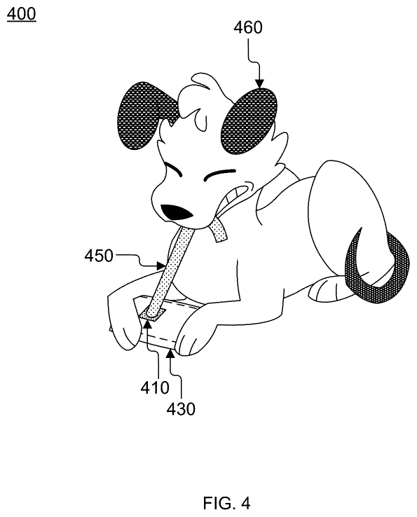

Referring now to FIG. 4, an exemplary enrichment system 400 being used by an animal user 460, according to some embodiments of the present disclosure, is illustrated. In some aspects, the enrichment system 400 may comprise at least one opening 410, wherein the at least one opening 410 may facilitate the removal of at least one portion of each of one or more removably insertable elements 450. By way of example and not limitation, each removably insertable element 450 may comprise at least one non-fraying, non-shedding, and non-edible material. In some aspects, the enrichment system 400 may comprise at least one internal cavity 420, wherein the internal cavity 420 may be configured to receive and at least temporarily store at least one portion of each removably insertable element 450. In some aspects, the enrichment system 400 may comprise a plurality of internal cavities 420.

In some implementations, each removably insertable element 450 may comprise an at least partially flexible elongated member comprising at least one non-fraying material, such as a strip or a strap, as non-limiting examples. In some aspects, a user may be able to pull each removably insertable element 450 from the internal cavity 420 of the enrichment system 400 through at least one of the openings 410, which may facilitate entertainment, stimulation, or enrichment for the user. In some non-limiting exemplary embodiments, the internal cavity 420 may be configured to hold at least six removably insertable elements 450 in the form of strips, straps, or similar structures. In some implementations, the enrichment system 400 may comprise at least one housing 430, wherein one or more openings 410 may be configured within an external surface of the housing 430, and wherein at least one internal cavity 420 may be configured within the housing 430 such that access to the cavity 420 and any removably insertable elements 450 therein may be facilitated by the openings 410.

As a non-limiting illustrative example, an animal user 460 of the enrichment system 400 may comprise a pet, such as a dog, cat, or rabbit. In some aspects, the animal user 460 may comprise a dog, and the dog may use one or more teeth to pull one or more removably insertable elements 450 through one or more openings 410 of the enrichment system 400 from the internal cavity 420, which may mimic pulling stuffing from a stuffed animal. In some implementations, the non-fraying and non-edible nature of elongated members comprising the removably insertable elements 450 may cause the removably insertable elements 450 to be unlikely to be ingested by the dog. In some aspects, this may help reduce the possibility that the dog may ingest potentially harmful materials while still allowing the dog to engage in a natural tendency to rip, tear, pull, or otherwise remove the interior portions of a toy.

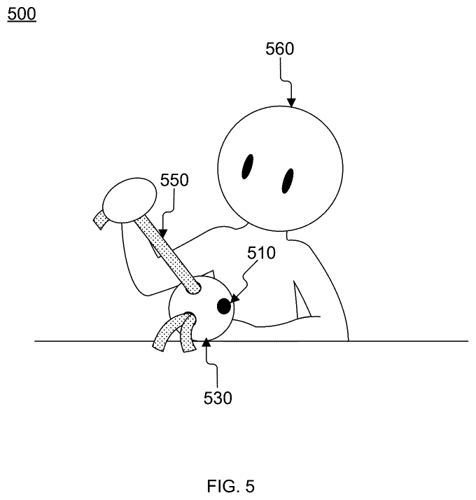

Referring now to FIG. 5, an exemplary enrichment system 500 being used by a human user 560, according to some embodiments of the present disclosure, is illustrated. In some aspects, the enrichment system 500 may comprise at least one opening 510, wherein the opening 510 may facilitate the removal of at least one portion of each of one or more removably insertable element 550. By way of example and not limitation, each removably insertable element 550 may comprise at least one non-fraying, non-shedding, and non-edible material. In some aspects, the enrichment system 500 may comprise at least one internal cavity, wherein the internal cavity may be configured to receive and at least temporarily store at least one portion of each removably insertable element 550. In some aspects, the enrichment system 500 may comprise a plurality of internal cavities. In some embodiments, the enrichment system 500 may comprise at least one housing 530, wherein one or more openings 510 may be configured within an external surface of the housing 530, and wherein at least one internal cavity may be configured within an internal portion of the housing 530 such that access to the cavity and any removably insertable elements 550 therein may be facilitated by the openings 510.

As a non-limiting illustrative example, a human user 560 may engage in use of the enrichment system 500. In some aspects, a human user 560 may benefit from using the enrichment system 500 to receive assistance with improving mobility or motor skills, receive mental stimulation, or engage in an entertaining experience by attempting to remove one or more removable insertable elements 550 from the internal cavity through one or more of the openings 510. In some implementations, the enrichment system 500 may be used in educational or occupational therapy settings, as non-limiting examples.

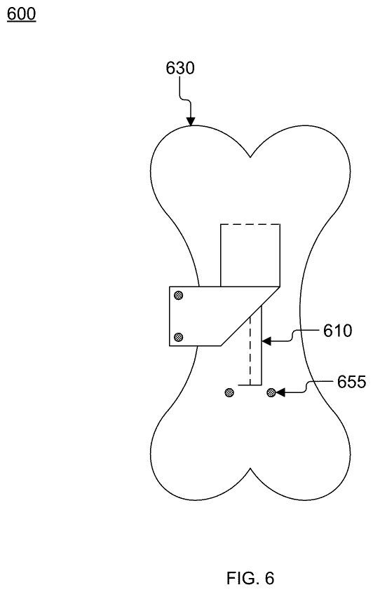

Referring now to FIG. 6, a top view of an exemplary enrichment system 600, according to some embodiments of the present disclosure, is illustrated. In some aspects, the enrichment system 600 may comprise at least one opening 610, wherein the opening 610 may facilitate the removal of at least one portion of one or more removably insertable elements. In some implementations, each opening 610 may comprise one or more of a variety of shapes, such as a circle, slit, triangle, or bone shape, as non-limiting examples. In some embodiments, the opening 610 may comprise at least one opening mechanism 655, such as, for example and not limitation, a snapping mechanism, a zipper, or a hook-and-loop fastener, wherein the opening mechanism 655 may provide a removable barrier that may need to be manipulated or otherwise engaged by a user to access the opening 610.

In some aspects, each removably insertable element may comprise at least one non-fraying, non-shedding, and non-edible material. In some implementations, the enrichment system 600 may comprise at least one internal cavity, wherein the internal cavity may be configured to receive and at least temporarily store at least portion of each of the removably insertable elements. In some aspects, the enrichment system 600 may comprise a plurality of internal cavities. In some embodiments, the enrichment system 600 may comprise at least one housing 630, wherein one or more openings 610 may be configured within an external surface of the housing 630, and wherein at least one internal cavity may be configured within the housing 630 such that access to the cavity and any removably insertable elements therein may be facilitated by the openings 610.

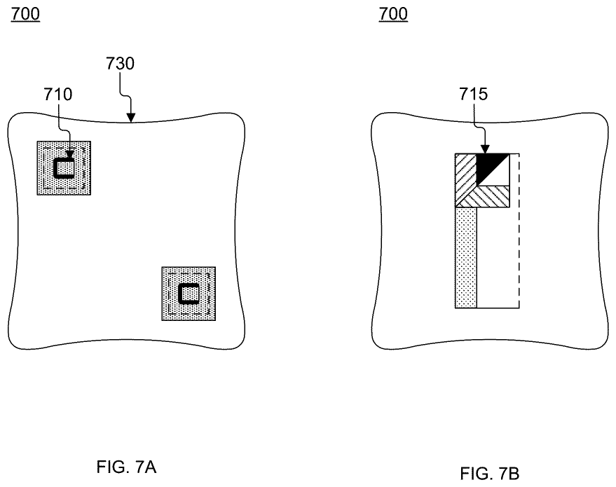

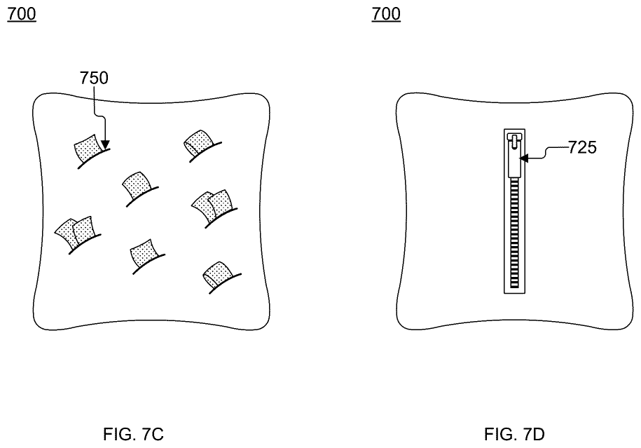

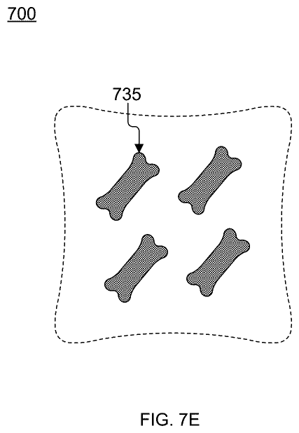

Referring now to FIGS. 7A, 7B, 7C, 7D, and 7E, top and bottom views of an exemplary enrichment system 700, according to some embodiments of the present disclosure, are illustrated. In some aspects, the enrichment system 700 may comprise at least one opening 710, wherein the opening 710 may facilitate the removal of at least one portion of each of one or more of removably insertable elements 750. In some embodiments, the opening 710 may comprise one or more of a variety of different shapes or configurations, such as a circle, slit, triangle, or bone shape, as non-limiting examples.

In some implementations, an external surface of a housing 730 of the enrichment system 700 may comprise at least one secondary opening configured to facilitate insertion of one or more removably insertable elements that have been completely removed from the housing 730. In some aspects, the secondary opening may be alterable between a closed state and an open state, wherein at least one portion of one or more removably insertable elements may be inserted into or removed from the housing 730 when the secondary opening is in an at least partially open state. In some embodiments, the secondary opening may be altered to a closed state when at least one closure mechanism substantially blocks access to the secondary opening. By way of example and not limitation, the closure mechanism may comprise at least one zipper 725, at least one hook-and-loop fastener 715, at least one snapping mechanism, or at least one flap of material or pocket, as non-limiting examples, as well as any similar mechanism or any combination thereof.

In some non-limiting exemplary implementations, each removably insertable element 750 may comprise at least one non-fraying, non-shedding, and non-edible material. In some aspects, the enrichment system 700 may comprise at least one internal cavity, wherein the internal cavity may be configured to receive and at least temporarily store at least one portion of each removably insertable element 750. In some aspects, the enrichment system 700 may comprise a plurality of internal cavities. As a non-limiting illustrative example, an internal cavity may be configured to hold at least six removably insertable elements in the form of strips, straps, or similar structures. In some embodiments, the enrichment system 700 may comprise at least one housing 730, wherein one or more openings 710 may be configured within an external surface of the housing 730, and wherein at least one internal cavity may be configured within an internal portion of the housing 730 such that access to the cavity and any removably insertable elements 750 therein may be facilitated by the openings 710.

In some aspects, one or more food items, such as, for example and not limitation, one or more dog treats 735 may be placed within the internal cavity of the housing 730 via the secondary opening, such that an animal user in the form of a dog may receive enrichment and stimulation by attempting to remove the treats 735 via one or more of the openings 710.

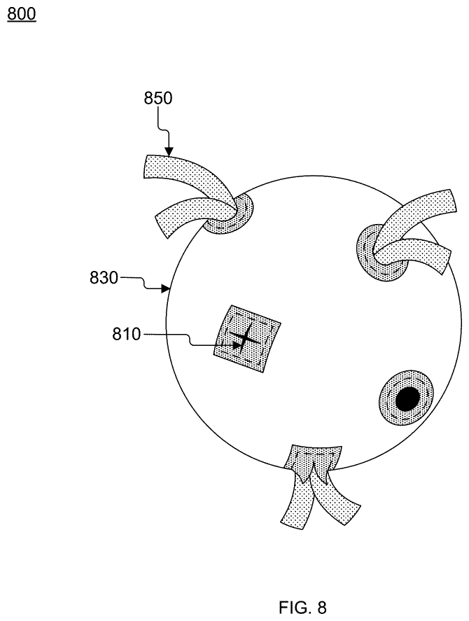

Referring now to FIG. 8, an exemplary enrichment system 800, according to some embodiments of the present disclosure, is illustrated. In some aspects, the enrichment system 800 may comprise at least one opening 810, wherein the opening 810 may facilitate the removal of at least one portion of each of one or more of removably insertable elements 850. By way of example and not limitation, each removably insertable element 850 may comprise at least one non-fraying, non-shedding, and non-edible material. In some aspects, the enrichment system 800 may comprise at least one internal cavity, wherein the internal cavity may be configured to receive and at least temporarily store at least portion of each removably insertable element 850. In some aspects, the enrichment system 800 may comprise a plurality of internal cavities. In some non-limiting exemplary embodiments, an internal cavity may be configured to hold at least six removably insertable elements in the form of strips, straps, or similar structures. In some embodiments, the enrichment system 800 may comprise at least one housing 830 in the shape of a sphere or ball, wherein one or more openings 810 may be configured within an external surface of the housing 830, and wherein at least one internal cavity may be configured within an interior portion the housing 830 such that access to the cavity and any removably insertable elements 850 therein may be facilitated by the openings 810.

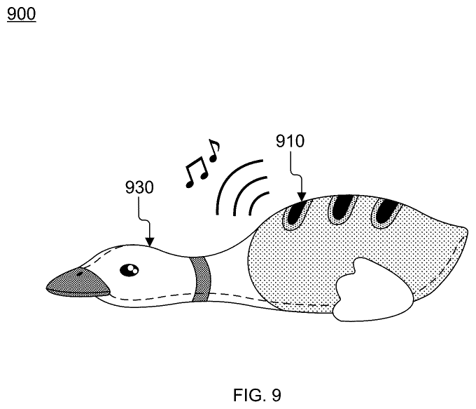

Referring now to FIG. 9, an exemplary enrichment system 900, according to some embodiments of the present disclosure, is illustrated. In some aspects, the enrichment system 900 may comprise at least one opening 910, wherein the opening 910 may facilitate the removal of at least one portion of each of one or more of removably insertable elements. In some non-limiting exemplary embodiments, at least one of the removably insertable elements may comprise an element that is not configured to be removed through the openings 910. By way of example and not limitation, at least one removably insertable element may comprise an element that emits a noise or sound when an amount of force or pressure is applied thereto, such as, for example and not limitation, a squeaking mechanism or similar audio emitting device. In some non-limiting exemplary implementations, one or more of the removably insertable elements may comprise at least one non-fraying, non-shedding, and non-edible material.

In some aspects, the enrichment system 900 may comprise at least one internal cavity, wherein the internal cavity may be configured to receive and at least temporarily store at least one portion of each removably insertable element. In some aspects, the enrichment system 900 may comprise a plurality of internal cavities. In some embodiments, an internal cavity may be configured to hold at least six removably insertable elements in the form of strips, straps, or similar structures. In some implementations, the enrichment system 900 may comprise at least one housing 930, wherein one or more openings 910 may be configured within an external surface of the housing 930, and wherein at least one internal cavity may be configured within an interior portion of the housing 930 such that access to the internal cavity and one or more of the removably insertable elements therein may be facilitated by the openings 910. In some aspects, the housing 930 may comprise one or more of a variety of shapes and sizes. By way of example and not limitation, in some implementations wherein a user may comprise a dog, the housing 930 may comprise a duck, bone, or similar shape, that may be appealing to the dog, as non-limiting examples.

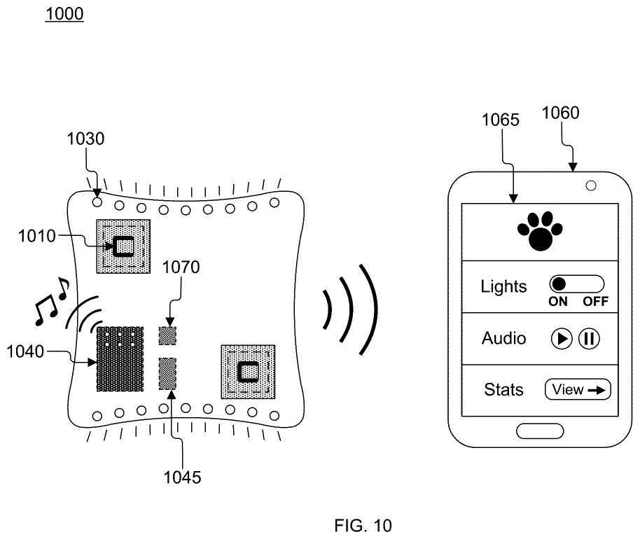

Referring now to FIG. 10, an exemplary enrichment system 1000, according to some embodiments of the present disclosure, is illustrated. In some aspects, the enrichment system 1000 may comprise at least one opening 1010, wherein the opening 1010 may facilitate the removal of at least one portion of each of one or more of removably insertable elements. By way of example and not limitation, each removably insertable element may comprise at least one non-fraying, non-shedding, and non-edible material. In some aspects, the enrichment system 1000 may comprise at least one internal cavity, wherein the internal cavity may be configured to receive and at least temporarily store at least one portion of each removably insertable element. In some aspects, the enrichment system 1000 may comprise a plurality of internal cavities. In some embodiments, for example and not limitation, an internal cavity may be configured to hold at least six removable insertable elements in the form of strips, straps, or similar structures.

In some implementations, the enrichment system 1000 may comprise at least one housing 1030, wherein one or more openings 1010 may be configured within an external surface of the housing 1030, and wherein at least one internal cavity may be configured within the housing 1030 such that access to the cavity and any removably insertable elements therein may be facilitated by the openings 1010. In some aspects, the housing 1030 of the enrichment system 1000 may comprise at least one sensing device 1045, wherein the at least one sensing device 1045 may be configured to detect at least one datum associated with use of the enrichment system 1000. In some embodiments, the at least one sensing device 1045 may comprise one or more of: a motion sensor, a light sensor, a pressure sensor, or a temperature sensor, as non-limiting examples.

In some implementations, the housing 1030 of the enrichment system 1000 may comprise at least one audio emitting device 1040, wherein the audio emitting device 1040 may be configured to emit at least one sound. As a non-limiting illustrative example, the audio emitting device 1040 may be configured to emit a sound that may entertain, educate, or stimulate a user, such as music, instructions, or animal sounds, as non-limiting examples. In some aspects, the enrichment system 1000 may comprise at least one transmitting device 1070, wherein the at least one transmitting device 1070 may be configured to transmit the at least one datum detected by the at least one sensing device 1045. In some embodiments, the transmitting device 1070 may be communicatively coupled to at least one computing device 1060, wherein the at least one computing device 1060 may be configured to process or analyze the datum using at least one software application or similar coded instructions or algorithms.

In some implementations, the enrichment system 1000 may comprise at least one graphical user interface 1065 (“GUI”), wherein the GUI 1065 may be configured to be presented via at least one display device integrated with or communicatively coupled to the computing device 1060. In some embodiments, the GUI 1065 may be configured to present data or information received from the at least one transmitting device 1070 by the computing device 1060. In some aspects, the GUI 1065 may be configured to enable a user to interact with one or more elements or components of the enrichment system 1000. By way of example and not limitation, the computing device 1060 may display a GUI 1065 that may allow user to remotely activate one or more sensing devices 1045, audio emitting devices 1040, or other hardware integrated into the enrichment system 1000. By way of further example and not limitation, the computing device 1060 may display a GUI 1065 that may allow a user to view data gathered by the sensing device(s) 1045, wherein the presentation of the data may comprise a visual or audio report of the data, as non-limiting examples. In some aspects, this may allow a user to monitor use of the enrichment system 1000.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

What is claimed is:

1. An enrichment system comprising:
at least one housing, wherein the at least one housing comprises at least one internal cavity configured within an interior portion of the at least one housing;
at least one opening; and
one or more removably insertable elements, wherein the one or more removably insertable elements are configured to be at least temporarily stored within the at least one internal cavity, wherein the at least one opening may facilitate removal of at least one portion of each of the one or more removably insertable elements from the at least one internal cavity.

2. The enrichment system of claim 1, wherein the at least one housing further comprises at least one secondary opening configured to facilitate insertion of the one or more removably insertable elements into the at least one internal cavity.

3. The enrichment system of claim 2, further comprising at least one closure element, wherein the at least one closure element is configured to alter the at least one secondary opening between a closed state and an open state, wherein access to the at least one secondary opening is blocked by the at least one closure mechanism when the at least one secondary opening is in the closed state.

4. The enrichment system of claim 3, wherein the one or more removably insertable elements are insertable into the at least one internal cavity when the at least one at least one secondary opening is in an at least partially open state.

5. The enrichment system of claim 3, wherein the at least one closure element comprises one or more of: a snapping mechanism, a zipper, a flap, and a hook-and-loop fastener.

6. The enrichment system of claim 1, wherein the at least one opening comprises at least one elongated slit.

7. The enrichment system of claim 6, wherein the at least one elongated slit comprises a length of approximately one inch.

8. The enrichment system of claim 1, wherein each of the one or more of removably insertable elements comprises an at least partially flexible elongated member.

9. The enrichment system of claim 8, wherein the at least partially flexible elongated member comprises at least one of: a strip and a strap.

10. The enrichment system of claim 8, wherein the at least partially flexible elongated member comprises at least one non-fraying material.

11. The enrichment system of claim 8, wherein the at least partially flexible elongated member comprises at least one elastic material.

12. The enrichment system of claim 1, wherein at least one of the one or more removably insertable elements comprises at least one edible element.

13. The enrichment system of claim 8, wherein each of the one or more removably insertable elements is configured to be completely removed from the at least one internal cavity.

14. The enrichment system of claim 13, wherein each of the one or more removably insertable elements is configured to be reinserted into the at least one internal cavity after being removed therefrom.

15. The enrichment system of claim 1, wherein the at least one internal cavity comprises a plurality of internal cavities.

16. The enrichment system of claim 1, wherein the at least one opening comprises a plurality of openings.

17. The enrichment system of claim 1, wherein the at least one housing further comprises at least one audio emitting device.

18. The enrichment system of claim 1, wherein the at least one housing further comprises at least one sensing device, wherein the at least one sensing device is configured to detect at least one datum associated with use of the enrichment system.

19. The enrichment system of claim 18, further comprising at least one transmitting device, wherein the at least one transmitting device is configured to transmit the at least one datum detected by the at least one sensing device to at least one computing device.

20. The enrichment system of claim 18, wherein the at least one sensing device comprises one or more of: a motion sensor, a light sensor, a pressure sensor, or a temperature sensor.
